(19) United States
(12) Patent Application Publication
(10) Pub. No.: US 2022/0114847 A1
(43) Pub. Date: Apr. 14, 2022

(54) SMART BOX

(71) Applicant: Igloo Products Corp., Katy, TX (US)

(72) Inventors: Jason Emde, Ballwin, MO (US); Geoff Truskowski, Saint Louis, MO (US); Greg Siwak, Clayton, MO (US); John Maldonado, Katy, TX (US); Vasanthi Iyer, Wilmington, DE (US); Nicholas Dekeyser, Katy, TX (US); Roque Barros, Katy, TX (US); Brad Thompson, Houston, TX (US); Jeff Diamond, Torrance, CA (US); Michelle Stone, Cypress, TX (US)

(21) Appl. No.: 17/246,132

(22) Filed: Apr. 30, 2021

Related U.S. Application Data
(60) Provisional application No. 63/091,071, filed on Oct. 13, 2020.

(51) Int. Cl. G07C 9/00; G07C 9/30; F25D 3/08

(52) U.S. Cl. CPC G07C 9/00182; H04N 7/183; F25D 3/08; G07C 9/30

(57) ABSTRACT

A smart box cooler having a computing device is provided. The smart box cooler can obtain authorization data, and determine whether the authorization data authorizes access to a cavity of the smart box cooler. The smart box cooler can activate an electrically operated actuator to control access to the cavity.

### RELATED APPLICATIONS

The present application claims the benefit of priority to U.S. Provisional Application No. 63/091,071, entitled “SMART BOX”, filed on Oct. 13, 2020, the entirety of which is incorporated herein by reference in its entirety.

### TECHNICAL FIELD

The present disclosure relates generally to coolers, and more particularly, to a smart box cooler.

### BACKGROUND

For years, it has been problematic for delivery service providers to fulfill many types of direct to consumer orders. Online marketplaces and merchants exist that allow consumers to purchase goods or services (e.g., groceries, meals or meal services, frozen or fresh food, household goods, small electronics, pet products, pharmaceuticals, and healthcare items) that can be delivered by a delivery service provider directly to a location specified by the consumer. However, storage of the goods can be challenging if the consumer is not at the location when the delivery service provider arrives. This can lead to the items being left by the delivery service provider in unsuitable locations. Leaving frozen or fresh food in front of a consumer's door, for example, can result in spoilage. Better solutions for contactless delivery are needed.

### BRIEF DESCRIPTION OF THE DRAWINGS

The accompanying drawings illustrate only various embodiments of a smart box cooler and method and therefore are not to be considered limiting of the scope of this disclosure. The principles illustrated in the various embodiments of the drawings can be applied to alternate methods and apparatus. Additionally, the elements and features shown in the drawings are not necessarily to scale, emphasis instead being placed upon clearly illustrating the principles of the various embodiments. Certain dimensions or positions may be exaggerated to help visually convey such principles. In the drawings, the same reference numerals used in different embodiments designate like or corresponding, but not necessarily identical, elements.

FIG. 1A shows a perspective view of a smart box cooler in accordance with various embodiments of the disclosure.

FIG. 1B shows a side view of the smart box cooler in accordance with various embodiments of the disclosure.

FIG. 1C shows a top view of a delivery assembly of the smart box cooler in accordance with various embodiments of the disclosure.

FIG. 1D shows a perspective view of a support element, a thermal storage divider, and a wire basket of the smart box cooler in accordance with various embodiments of the disclosure.

FIG. 1E shows a front cross section view of an insulation layer, a first cavity, and a second cavity of the smart box cooler in accordance with various embodiments of the disclosure.

FIG. 1F shows a perspective view of a support element of the liner of the smart box cooler in accordance with various embodiments of the disclosure.

FIG. 1G shows a front view of the smart box cooler in accordance with various embodiments of the disclosure.

FIG. 1H shows a drain plug assembly of the smart box cooler in accordance with various embodiments of the disclosure.

FIG. 1I shows a rear view of the delivery lid coupled to the liner of the smart box cooler in accordance with various embodiments of the disclosure.

FIG. 1J shows a bottom view of the smart box cooler in accordance with various embodiments of the disclosure.

FIG. 1K shows a strike plate or catch of the liner of the smart box cooler in accordance with various embodiments of the disclosure.

FIGS. 1L and 1M show a delivery assembly of the delivery lid of the smart box cooler in accordance with various embodiments of the disclosure.

FIG. 1N shows a lock mechanism and an electrically operated actuator of the smart box cooler in accordance with various embodiments of the disclosure.

FIG. 1O shows the lock mechanism of the smart box cooler in accordance with various embodiments of the disclosure.

FIG. 2 is a drawing of an example of a network environment according to various embodiments of the present disclosure.

FIGS. 3A-3H are drawings of user interfaces according to various embodiments of the present disclosure.

FIG. 4A is an example flowchart illustrating functionalities implemented by a smart box cooler application of the smart box cooler according to various embodiments of the present disclosure.

FIG. 4B is an example flowchart illustrating functionalities implemented by an administration application according to various embodiments of the present disclosure.

FIG. 4C is an example flowchart illustrating functionalities implemented by a client application according to various embodiments of the present disclosure.

### DETAILED DESCRIPTION

The present disclosure relates to a smart box cooler that can provide a contactless, food temperature safe, and secure solution for delivery of items. Items (e.g., anything deliverable or that a consumer may desire to keep insulated or secure) can be placed in a cavity of the smart box cooler storage. The smart box cooler, a smart box service, and at least one client device can be in communication over the network.

In some examples, systems and methods of the smart box cooler include obtaining an initiation action comprising authorization data, and determining whether the authorization data is authorized. The smart box cooler can activate an electrically operated actuator to control access to a cavity of the smart box cooler. Activating the electrically operated actuator, can, in some examples, include causing the electrically operated actuator to be energized or deenergized. Some aspects of the disclosure provide that activating the electrically operated actuator prevents a lock mechanism of the smart box cooler from being unlocked.

In an instance in which the authorization data is determined to be authorized, the smart box cooler can initiate access to the cavity of the smart box cooler. In an example, the smart box cooler can obtain, by a keypad, the authorization data including a first personal identification number associated with a delivery user. In an instance in which access to the cavity of the smart box cooler is initiated for the delivery user, the smart box cooler can transmit a notification to a client device. The smart box cooler can obtain, by the keypad, a second personal identification number and determine that the second personal identification number is associated with a user of the client device. Access to the cavity can be initiated for the user of the client device. The smart box service can obtain a status that indicates whether access to the cavity of the smart box cooler has been provided.

In further examples, systems and methods of administration for the smart box cooler are provided. A smart box service can identify a delivery including at least one item of an order placed by a user of the client device. The smart box service can identify user data including a personal identification number that is associated with the delivery or the order, and transmit the personal identification number (PIN) to the smart box cooler. In some examples, the smart box service transmits an indication that the PIN does not expire, an expiration date of the PIN, or a predefined number of uses of the PIN. One or more user interfaces can be generated by the smart box service. In some aspects, the smart box service can determine a number of uses of the PIN. In an instance in which the number of uses of the PIN is equal to a predefined number, the smart box service can cause an expiration of the PIN and transmit an indication of the expiration to the smart box cooler.

The smart box service can obtain video frames sent by a camera of the smart box cooler. One or more user interfaces generated by the smart box service can be configured to render a video based at least in part on the plurality of video frames.

In other examples, a client application for a client device is provided. The client application can render a delivery user interface with delivery data associated with an item of an order placed by a user of the client device, and generate (or receive) a personal identification number (PIN) for a delivery of the item at the smart box cooler.

The client application can render a delivery pin user interface with selectable user interface elements, including a selectable user interface element configured to receive an indication that the PIN does not expire; a selectable user interface element configured to receive an expiration date of the PIN, or a selectable user interface element configured to receive a predefined number of uses of the PIN.

The client application can receive a selection of at least one of the selectable user interface elements, and transmit the indication that the PIN does not expire, the expiration date of the PIN, or the predefined number of uses of the PIN based on the selection. The client device can transmit the indication to the smart box service or the smart box cooler.

In some aspects, the client application can render a video user interface comprising a video based at least in part on a plurality of video frames sent by the smart box cooler. The client application can render a user interface with an unlock user interface element. In an instance in which the unlock user interface element is selected, the client application can initiate access to a cavity of the smart box cooler. The client application can receive a notification in an instance in which access to the cavity of the smart box cooler is initiated.

Examples embodiments disclosed herein can extend beyond grocery delivery to prepared meal delivery, takeout home delivery, frozen/fresh food shipments, non-grocery product deliveries such as household goods, small electronics, pet products, pharmaceuticals, healthcare items, and more.

Hereinafter, embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

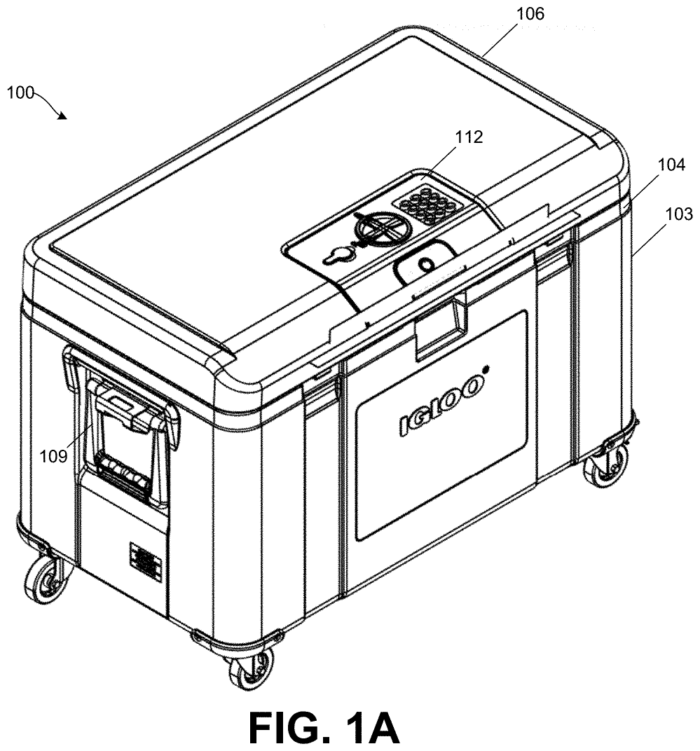

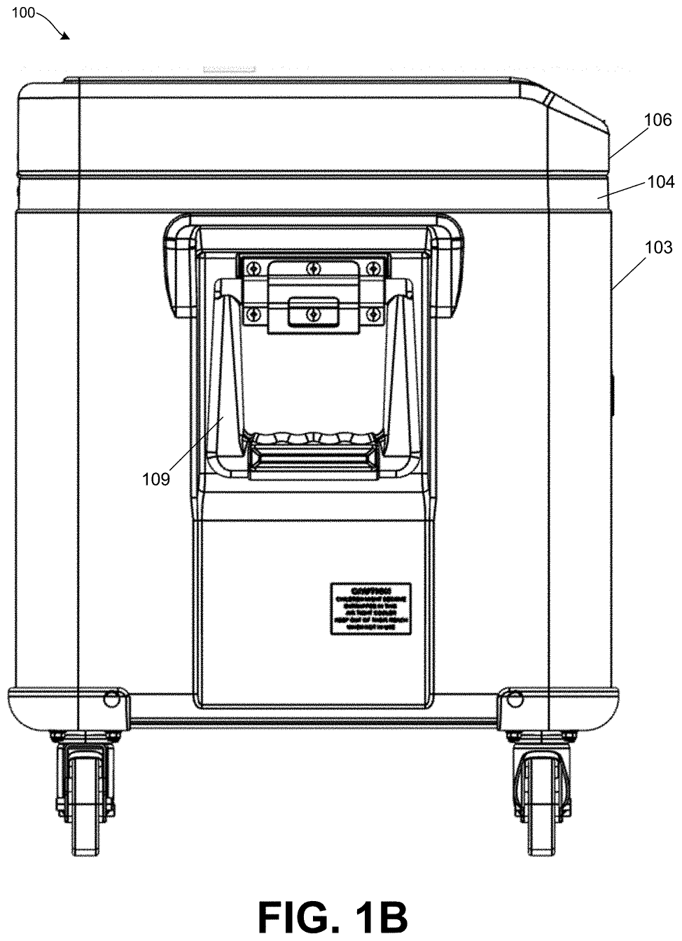

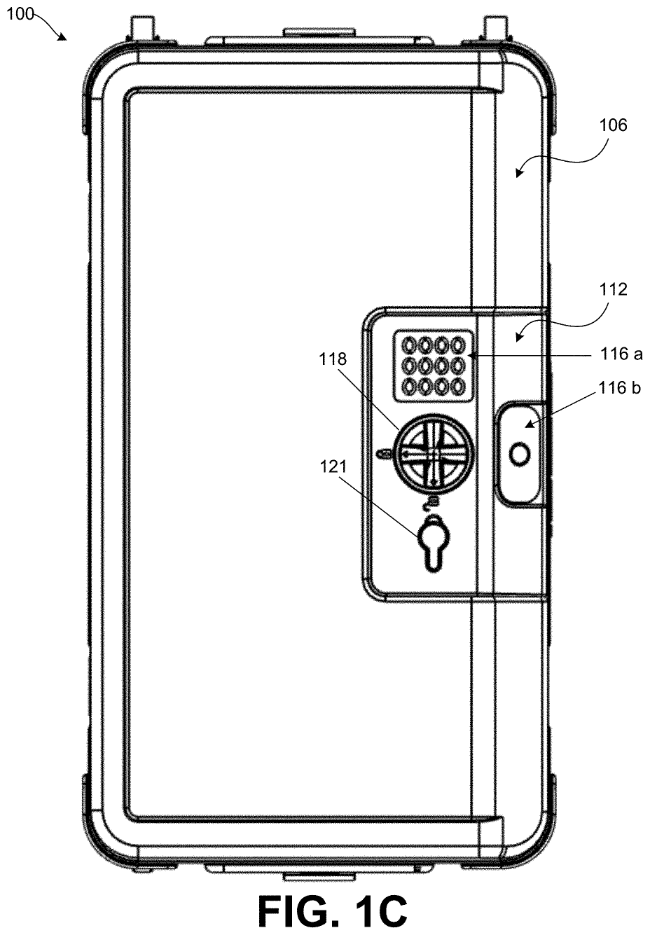

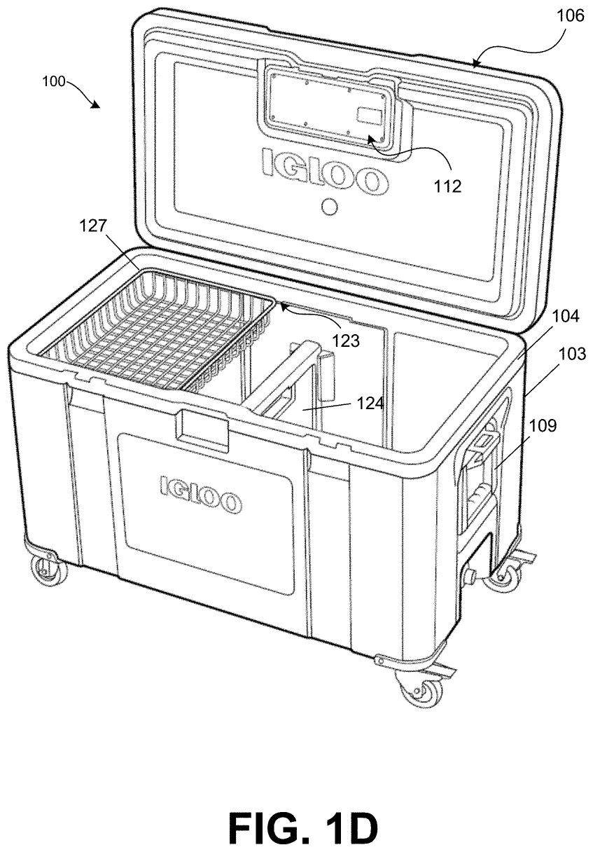

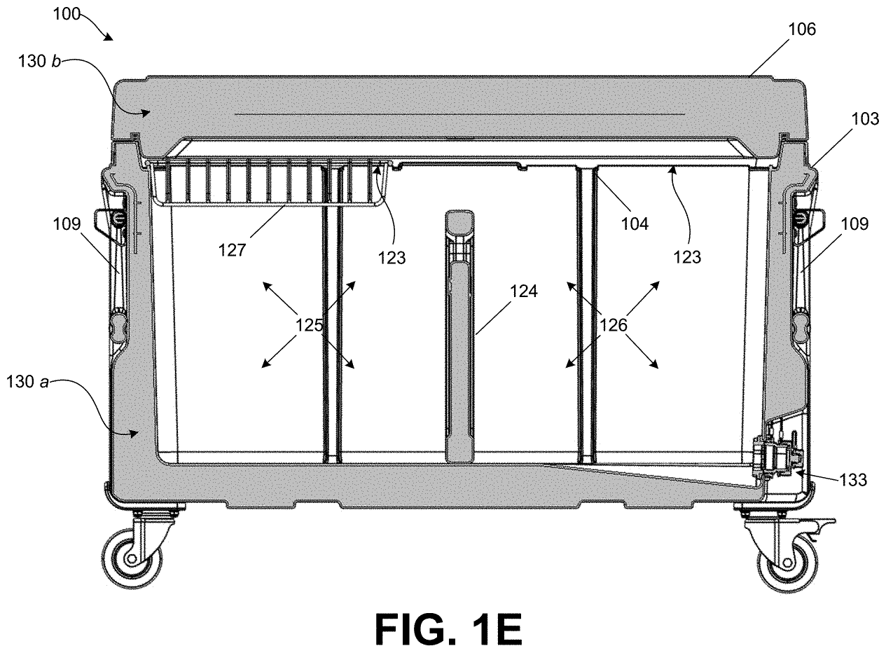

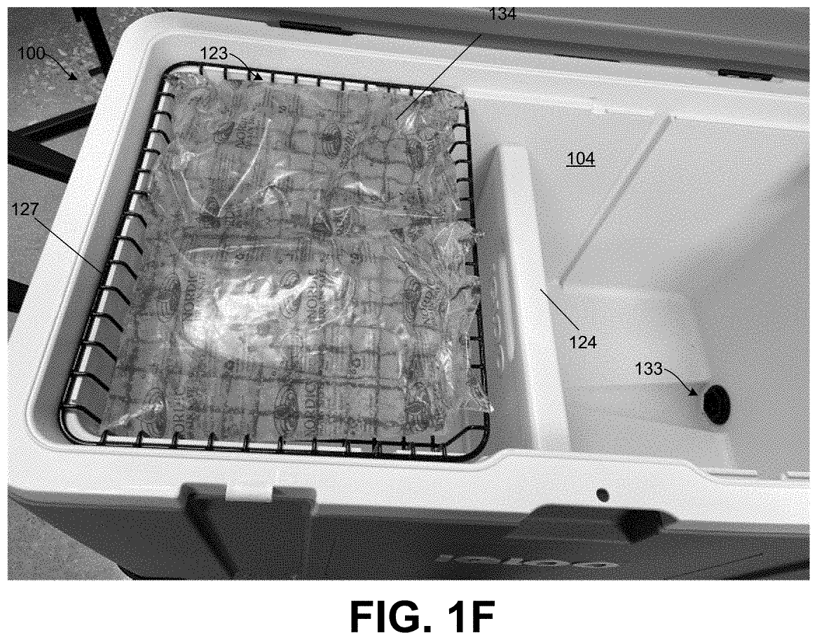

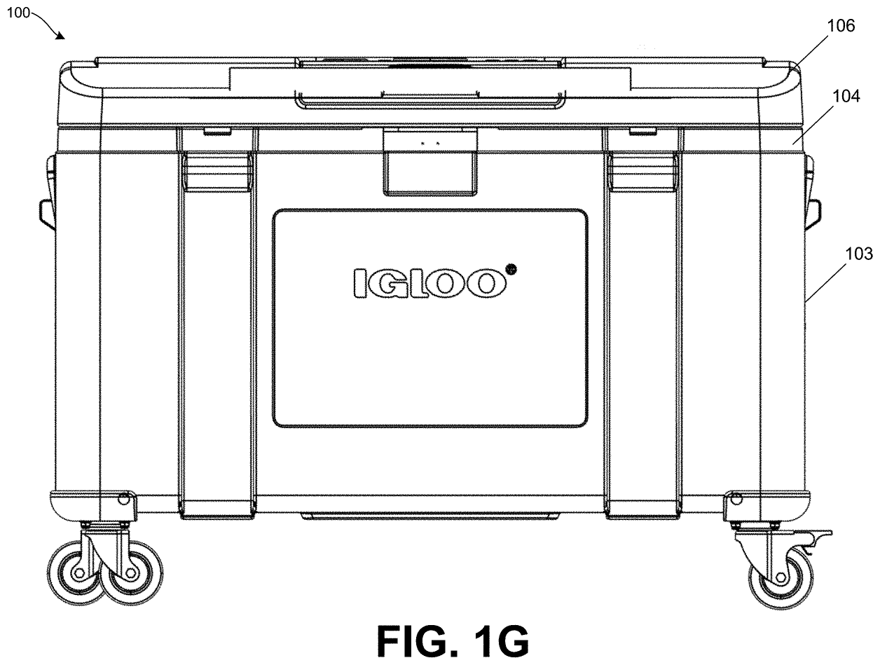

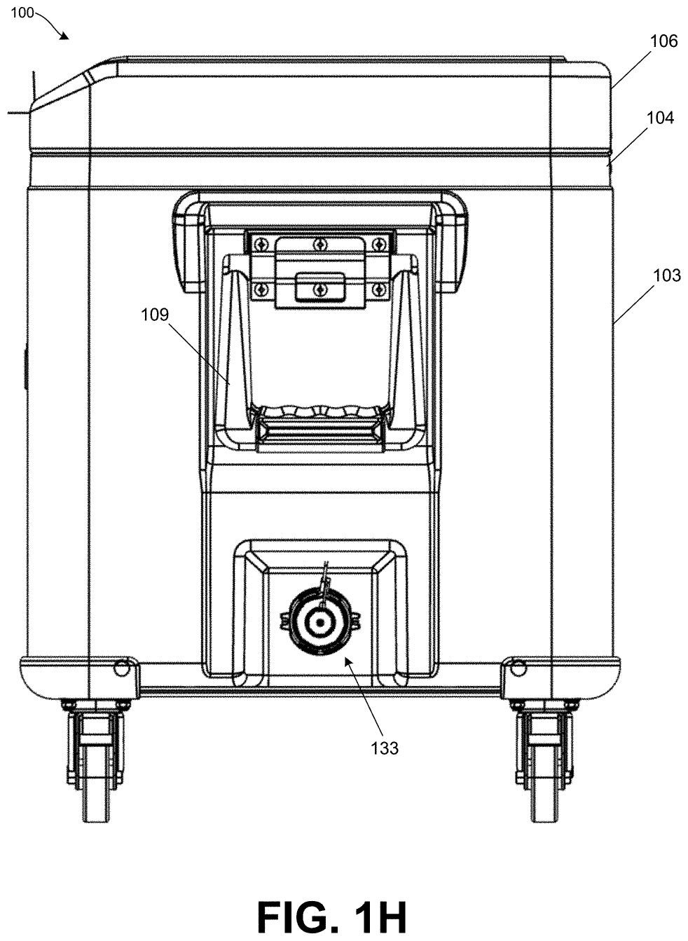

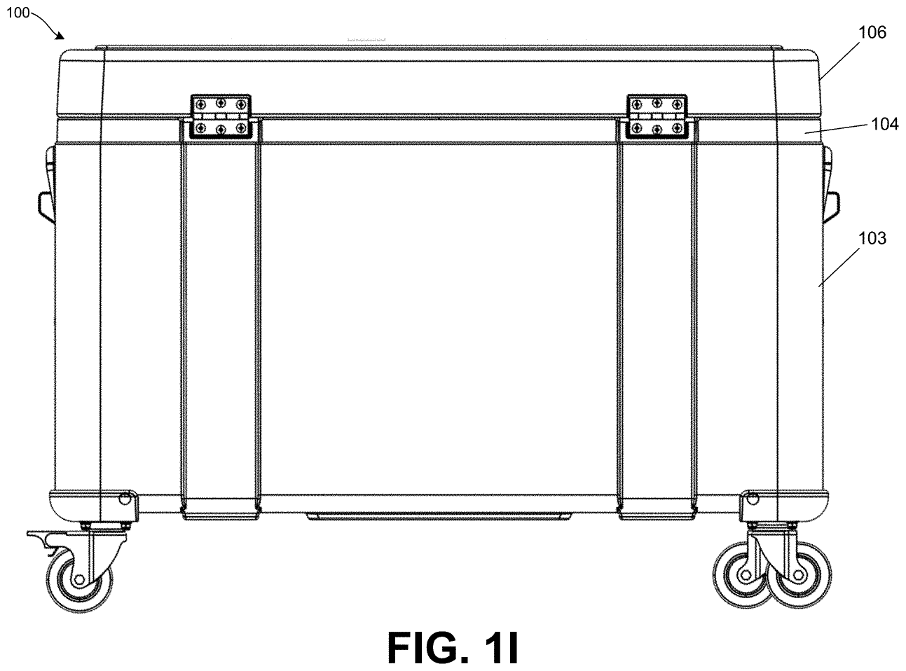

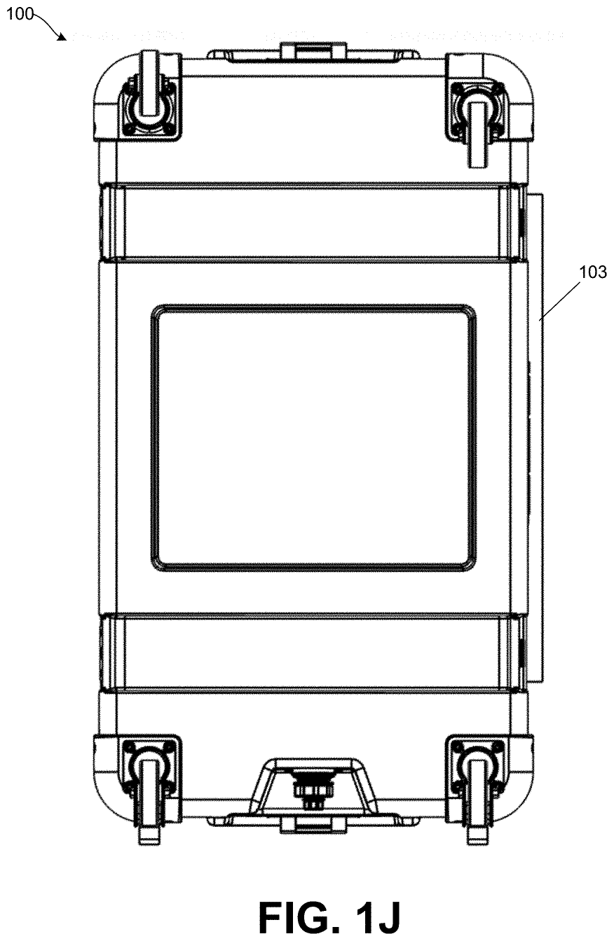

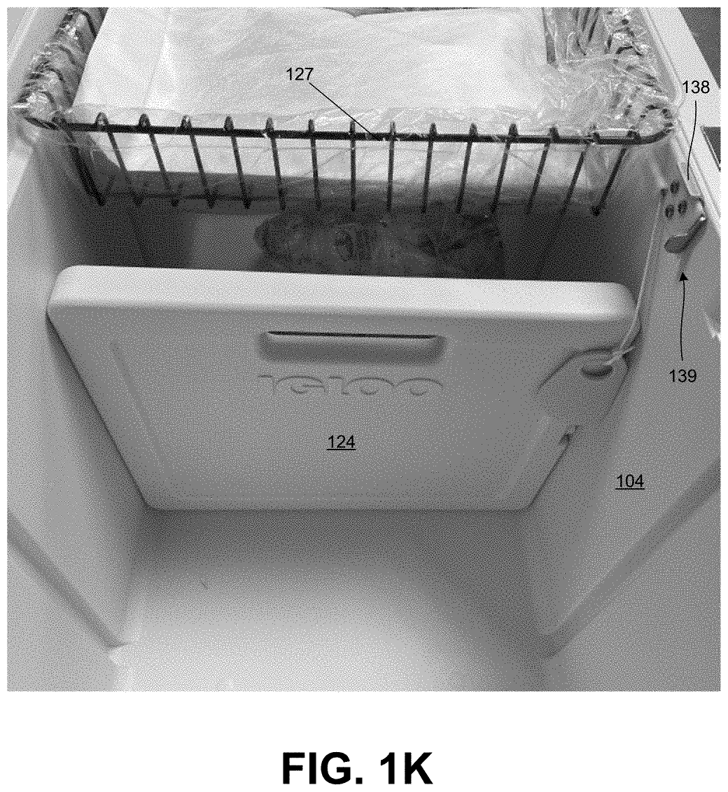

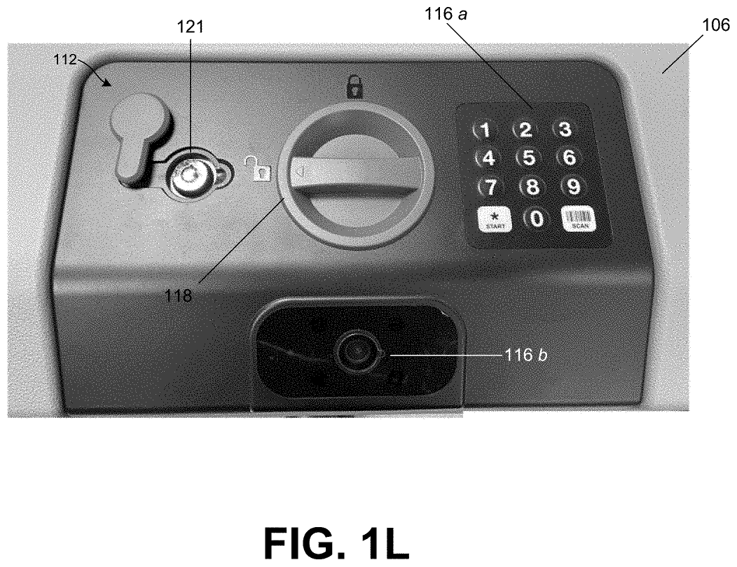

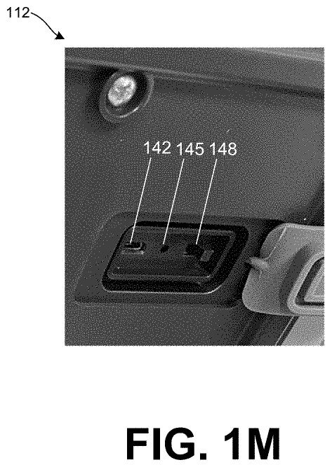

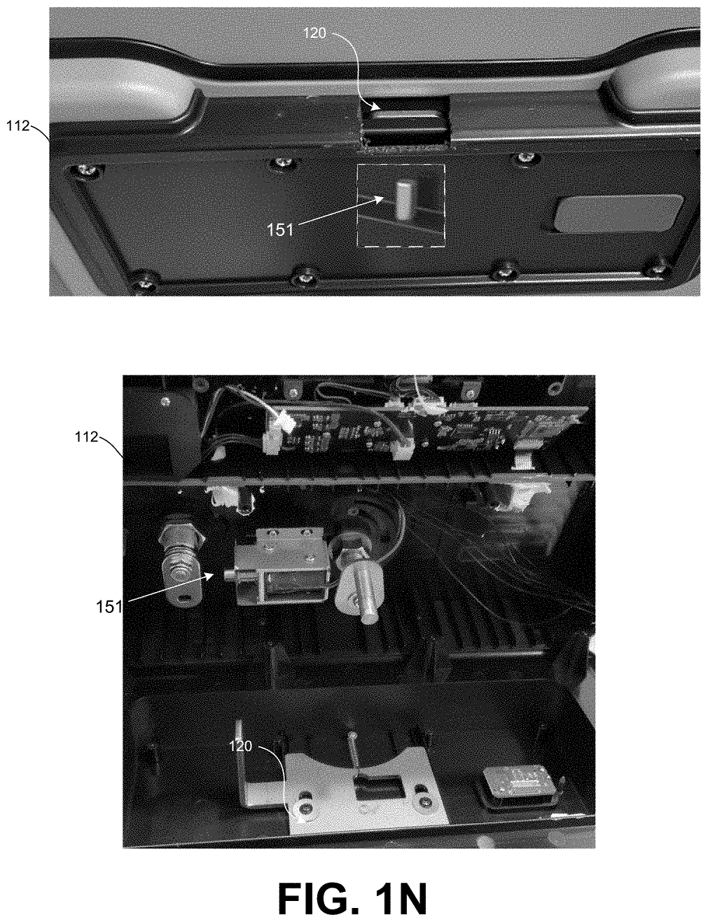

Referring now to examples of the present disclosure shown by FIGS. 1A-1O, FIG. 1A shows a perspective view of a smart box cooler 100 in accordance with various embodiments of the disclosure. FIG. 1B shows a side view of the smart box cooler 100 in accordance with various embodiments of the disclosure.

The smart box cooler 100 can include a cooler body 103 and a liner 104 that defines at least one cavity of the cooler body 103. Items (e.g., anything deliverable or that a consumer may desire to keep insulated against temperature loss) can be placed in the cavity for storage. The smart box cooler 100 can include an insulation layer between the cooler body 103 and the liner 104.

The smart box cooler 100 can include a delivery lid 106, and at least one handle 109. The delivery lid 106 can include an insulation layer for thermal efficiency and a lid gasket for thermal efficiency and weatherproofing.

The delivery lid 106 or the cooler body 103 can include a delivery assembly 112 having various features that will be more fully described below. FIG. 1A depicts the delivery lid 106 comprises the delivery assembly 112. The delivery lid 106 can be coupled to the liner 104 or the cooler body 103 and be adapted to close an opening that extends through the cooler body 103 and the liner 104 into the at least one cavity. For example, the delivery lid 106 can be coupled to the liner 104 by one or more hinges. The liner 104 can comprise antimicrobial additive that can destroy or inhibit the growth of microorganisms on the liner 104 or in the cavity.

The smart box cooler 100 can also include one or more tie-down point(s) to secure the smart box cooler 100 and deter theft of the smart box cooler 100. Some examples of the smart box cooler 100 provide wheels for easy mobility (e.g., to unload groceries inside the home or for moving the smart box cooler 100 to an alternative location for storage).

Turning now to FIG. 1C, shown is a top view of the delivery assembly 112 of the smart box cooler 100 in accordance with various embodiments of the disclosure. The delivery assembly 112 can include at least one computing device including at least one input device 116 comprising a keypad 116a, a camera 116b, a mouse, a keyboard, a touch pad, a touch screen, a scanner, or a microphone. The keypad 116a can be configured to receive a personal identification number (PIN) or any other suitable input. In one example operation, a “START” button can be engaged and a PIN entered via the keypad 116a. In another example, a “SCAN” button can be engaged to cause a barcode to be scanned. The camera 116b can be configured to a scan a barcode, stream live video, or record a video of a delivery. The camera 116b can allow anyone accessing the smart box cooler 100 to be visually monitored. Engaging one of the input devices 116 such as the keypad 116a can initiate a recording by the camera 116b.

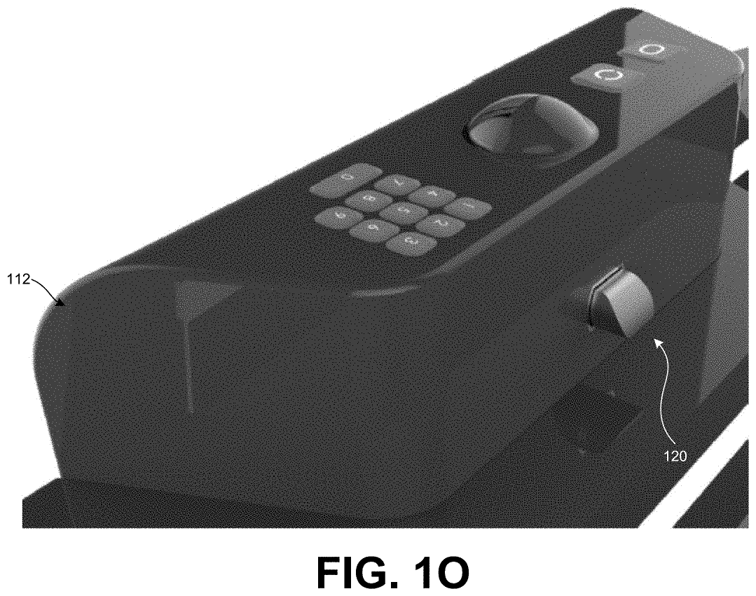

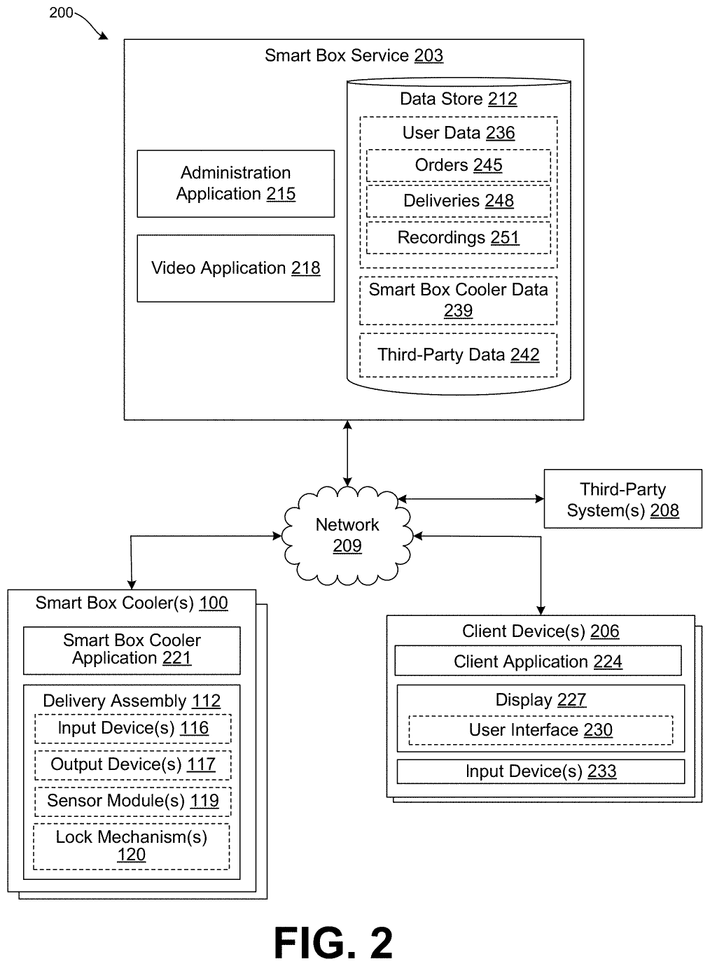

The delivery assembly 112 includes a lock mechanism 120 (FIGS. 1N, 1O, and 2) that can be adapted to be selectively locked or unlocked. The delivery assembly 112 can include a solenoid actuator or other electrically operated actuator 151 (FIG. 1N) that can be adapted to prevent the lock mechanism 120 from being unlocked, or to cause the lock mechanism 120 to be unlocked. The delivery assembly 112 and the lock mechanism 120 can provide the smart box cooler 100 with a locking lid for security or theft prevention of items placed in the cavity for storage.

The delivery assembly 112 can include a lock knob 118 that can cause the lock mechanism 120 to be selectively locked or unlocked. The lock knob 118 can rotate from a first or unlocked position to a second or locked position. In some examples, the lock knob 118 can be manually turned to latch or unlatch the smart box cooler 100. If a child climbs in the smart box cooler 100 and closes the delivery lid 106, the delivery lid 106 can remain unlatched (or unlocked) and the delivery lid 106 can rotate to open.

The delivery assembly 112 can include a secondary locking mechanism. For example, the delivery assembly 112 can include a master lock override 121 that is adapted to unlock the lock mechanism 120. The master lock override 121 can override the electrically operated actuator 151 of the delivery assembly 112. Additionally, the master lock override 121 can lock or unlock the lock mechanism 120 in the event of a power failure. In other examples, the keypad 116a can be used to override the electrically operated actuator 151 of the delivery assembly 112.

FIG. 1D shows a perspective view of a support element 123, a thermal storage divider 124, and a wire basket 127 of the smart box cooler 100 in accordance with various embodiments of the disclosure. FIG. 1E shows a front cross section view of the support element 123, the wire basket 127, a first cavity 125, a second cavity 126, and an insulation layer 130a of the smart box cooler 100 in accordance with various embodiments of the disclosure. FIG. 1F is a perspective view of the support element 123 of the liner 104 of the smart box cooler 100 in accordance with various embodiments of the disclosure. FIG. 1G shows a front view of the smart box cooler 100 in accordance with various embodiments of the disclosure.

The liner 104 can include the support element 123 that supports the wire basket 127 as depicted in FIGS. 1D and 1E. At least one thermal storage divider 124 can be positioned in the cavity formed by the liner 104 to define at least one of the first cavity 125 or the second cavity 126. The thermal storage divider 124 as depicted in FIGS. 1D-1F extends upward from a base of the liner 104. In certain aspects of this disclosure, the at least one thermal storage divider 124 provides an interior divider for compartmentalization of cold/frozen foods and maintaining a food safe temperature. The thermal storage divider 124 can comprise gel, water, or any substance suitable to be stored in the thermal storage divider 124.

FIG. 1E depicts that the support element 123 can be formed by the liner 104 at one or more locations adjacent to a bottom or underside of the delivery lid 106. The support element 123 is adapted to support a wire basket 127 that suspend at least one gel pack, ice block, or other thermal storage member 134 (FIG. 1F) in the at least one of the first cavity 125 or the second cavity 126.

The smart box cooler 100 can include an insulation layer 130a between an outer shell of the cooler body 103 and the liner 104 as depicted in FIG. 1E. Some examples of the smart box cooler 100 can include a delivery lid 106 that is insulated. As depicted in FIG. 1E, the delivery lid 106 can include an insulation layer 130b.

In some examples of operation, the insulation layer 130a, the insulation layer 130b, the thermal storage divider 124, the at least one thermal storage member 134, and the wire basket 127 are adapted to maintain a food safe temperature in the at least one of the first cavity 125 or the second cavity 126 for three or more hours. Examples of this disclosure can be used to maintain the food safe temperature for up to eight hours.

FIGS. 1F and 1H show the smart box cooler 100 can include a drain plug assembly 133 having a drain plug that is in fluid communication with the cavity formed by the liner 104. When the drain plug is removed, water or other fluid in the cavity can drain out of the drain plug assembly 133. Removing the drain plug allows emptying melted ice from the cavity.

FIG. 1I shows a rear view of the delivery lid 106 coupled to the liner 104 of the smart box cooler 100 with a plurality of hinges in accordance with various embodiments of the disclosure. FIG. 1J is a bottom view of the smart box cooler 100 in accordance with various embodiments of the disclosure. The smart box cooler 100 shown in FIG. 1J includes wheels for easy mobility.

Referring now to FIG. 1K, a strike plate 138 or a catch can be attached to the liner 104 of the smart box cooler 100 in accordance with various embodiments of the disclosure. In some other examples, the liner 104 can comprise the strike plate 138 or the catch. The example of FIG. 1K shows that a child safety assembly 139 comprising the strike plate 138 or the catch can be provided. The child safety assembly 139 can be adapted to move the strike plate 138 or the catch out of the way of the lock mechanism 120 of the delivery assembly 112 to prevent a person from being sealed inside the cavity of the smart box cooler 100.

FIGS. 1L and 1M show the delivery assembly 112 of the delivery lid 106 of the smart box cooler 100 in accordance with various embodiments of the disclosure. The delivery lid 106 (or the cooler body 103) can be formed to include a receptacle for containing the delivery assembly 112. The delivery assembly 112 can for example be removably fastened to the delivery lid 106 using one or more screws as shown in FIGS. 1M and 1N. The smart box cooler 100 comprising the delivery assembly 112 can be an IP55 rated product that is protected against dust ingress that could be harmful for the operation of the smart box cooler 100. The smart box cooler 100 can also be protected against solid objects and water intrusion.

FIG. 1L shows the lock knob 118 can rotate from a first or unlocked position to a second or locked position. The lock knob 118 in FIG. 1L is in the unlocked position as indicated by an arrow of the lock knob 118 pointing towards a representation of an unlocked lock. The lock knob 118 can rotate in a clockwise direction to the second or locked position to cause the lock mechanism 120 to engage.

FIG. 1M shows a bottom perspective view of the delivery assembly 112. The delivery assembly 112 can include a charging port 142, a reset button 145, or a power switch 148. The charging port 142 can be adapted to receive a connector that is in electrical communication with a power source for charging a battery that can power the smart box cooler 100. In some examples, the smart box cooler 100 is configured (through the charging port 142 or otherwise) to be electrically coupled to a power source (e.g., 120 VAC or 240 VAC) which typically provides voltage that alternates at a line frequency (e.g., 60 Hz in the U.S., 50 Hz in other countries).

FIG. 1N shows a lock mechanism 120 and an electrically operated actuator 151 of the smart box cooler in accordance with various embodiments of the disclosure. The electrically operated actuator 151 of FIG. 1N is depicted via an inset box shown in dotted lines. The electrically operated actuator 151 can be adapted to prevent the lock mechanism 120 from being unlocked or locked. For example, deenergizing (or energizing) the electrically operated actuator 151 can prevent the lock mechanism 120 from being unlocked. In other examples, deenergizing (or energizing) the electrically operated actuator 151 can prevent the lock mechanism 120 from being locked. Although the electrically operated actuator 151 of FIG. 1N is depicted as within a housing of the delivery assembly 112, the smart box cooler 100 can include the electrically operated actuator 151 in any location suitable to prevent the lock mechanism 120 from being unlocked or locked. In the present disclosure, the electrically operated actuator 151 or solenoid can be housed within a housing of the delivery assembly 112, and can prevent the locking tab (e.g., shown as the lock mechanism 120 in FIG. 1N) from sliding. In certain aspects, FIG. 1N is a photo of the underside of the delivery assembly 112 and a corresponding delivery lid 106. The inset of the upper image of FIG. 1N shows the electrically operated actuator 151 or solenoid can be adapted to prevent the lock mechanism 120 from being locked or unlocked. In some examples, the lock mechanism 120 can be locked or unlocked by rotating the lock knob 118. The electrically operated actuator 151 can prevent the lock knob 118 from fully turning to the unlocked (or locked) position. The electrically operated actuator 151 can retract (moves to the right in the lower image of FIG. 1N) when activated. The electrically operated actuator 151 (or a bolt of the electrically operated actuator 151), and a locking plate of the lock mechanism 120 can line up to prevent the plate from sliding forward. The lock knob 118 can slide the locking plate and a tab of the locking mechanism 120 (e.g., as indicated by the arrow in the upper image of FIG. 1N). The tab can engage the cooler body 103 or the liner 104 to prevent the delivery lid 106 from opening. In the lower image of FIG. 1N, sliding the plate forward is locked and backwards is unlocked.

FIG. 1O shows the lock mechanism 120 of the smart box cooler 100 in accordance with various embodiments of the disclosure. In this example, the delivery assembly 112 is adapted to be attached to or included in the cooler body 103. The lock mechanism 120 includes a latch or plunger that can interface (or be configured to interface) with a strike plate or catch attached to or included in the delivery lid 106. The latch or plunger can extend from the delivery assembly 112 into a lock cavity in the delivery lid 106, the cooler body 103, and/or the liner 104.

Turning to FIG. 2, shown is an example of a network environment 200 according to various embodiments of the present disclosure. FIG. 2 shows the network environment 200 can include the smart box cooler 100, a smart box service 203, at least one client device 206, and a third-party system 208 in data communication over a network 209. The network 209 can include the internet, one or more intranets, extranets, wide area networks (WANs), local area networks (LANs), wired networks, wireless networks, or any combination of two or more such networks. The network 209 can include satellite networks, cable networks, Ethernet networks, cellular networks, and telephony networks. In some examples, the client device 206 and the smart box cooler 100 communicate using Bluetooth, Bluetooth Low Energy, or other wireless personal area networks and protocols.

The smart box cooler 100 is representative of any one or more smart box coolers 100. The smart box cooler 100 can include a processor-based system, such as a computer system, an IoT device, microcontroller, or any other device with like capability. The smart box cooler 100 can comprise the delivery assembly 112 with the at least one input device 116, at least one output device 117, at least one sensor module 119, and the lock mechanism 120.

The at least one input device 116 can comprise the keypad 116a, the camera 116b, a mouse, a keyboard, a touch pad, a touch screen, a scanner, or a microphone. The at least one output device 117 can include a display, a siren, a speaker, a status indicator, or other suitable output device. The sensor module 119 can include one or more sensors including (but not limited to) accelerometer, gyroscope, magnetometer, or a satellite navigation (e.g., Global Positioning System) receiver. In an example operation, the sensor module 119 can detect movement of the smart box cooler 100.

The smart box service 203 can include a server computer or any other system providing computing capability. Alternatively, the smart box service 203 can include a plurality of computing devices that are arranged, for example, in one or more server banks, computer banks, or other arrangements. The computing devices can be located in a single installation or can be distributed among many different geographical locations. For purposes of convenience, the smart box service 203 is referred to in the singular, it is understood that a plurality of smart box services 203 can be employed in the various arrangements as described above. In some examples, one or more organizations can operate the smart box service 203 to oversee, facilitate, provide, or manage the operation(s) of the smart box cooler 100.

The client device 206 is representative of any one or more client devices 206. The client device 206 can include a processor-based system, such as a computer system, that can include a desktop computer, a laptop computer, a personal digital assistant, a cellular telephone, a smartphone, a tablet computer system, an IoT device, or any other device with like capability. The third-party system 208 may be any computing device, computing environment, data provider, service provider, or computing resource provider, which may be provided by a third-party or by the provider of the smart box service 203.

Also, data can be stored in a data store 212 that can be accessible to the smart box cooler 100, the smart box service 203, and the client device 206. The data store 212 can be representative of a plurality of data stores 212. The data stored in the data store 212 can be associated with the operation of the applications or functional entities as further described below.

Applications or other functionality can be executed in the network environment 200 according to examples. The smart box service 203 can include an administration application 215 and a video application 218. The administration application 215 can be executed to manage or configure the smart box coolers 100, and to facilitate interactions between the client devices 206 and the smart box coolers 100. The video application 218 can be executed to encode a plurality of video frames sent by the smart box cooler 100 for storing as the recordings 251, or for streaming to the client device 206.

The smart box cooler 100 can execute a smart box cooler application 221 to, among other things, control aspects of the smart box cooler 100 including the input devices 116, the output devices 117, the sensor modules 119, the lock mechanism 120, or the electrically operated actuator 151 (FIG. 1N). The client device 206 can execute a client application 224 to allow a user to interact with the smart box cooler 100 or the smart box service 203.

The client device 206 can include output devices such as audio speakers and a display 227 upon which user interface(s) 230 generated by the client application 224, or another application can be rendered. The display 227 can include liquid crystal display (LCD) displays, gas plasma-based flat panel displays, organic light emitting diode (OLED) displays, electrophoretic ink (E-ink) displays, LCD projectors, or other types of display devices, etc. The client device 206 can include one or more input devices 233, such as a mouse, keyboard, touch pad, or touch screen, which facilitate a user interacting with the client application 224 or controlling the client device 206.

The data stored in the data store 212 can include user data 236, smart box cooler data 239, third party data 242, and potentially other data. The smart box cooler data 239 can include a media access control (MAC) address of a network interface card (NIC), a serial number, one or more personal identification numbers (PIN), or other information about any of the smart box coolers 100. The third party data 242 can include a Uniform Resource Identifier (URI), other identifier that enables interactions with an application programming interface (API) associated with the third-party system 208 over the network 209, or other data about a third party (e.g., retailer or delivery service provider).

The user data 236 can include orders 245, deliveries 248, and recordings 251, or other data associated with usage of one or more of the smart box coolers 100. The user data 236 can include a certificate or other information that can be used to identify or authenticate a user of a particular smart box cooler 100. For example, the user data 236 can include one or more personal identification numbers (PIN) for a user of the client device 206, or one or more personal identification numbers (PIN) for a delivery user associated with one of the orders 245 of the deliveries 248.

The orders 245 can include data about orders placed by a user of the smart box cooler 100. The deliveries 248 can include a delivery name, a tracking number, a delivery route or an expected arrival date associated with a delivery to the smart box cooler 100. The recordings 251 can include a plurality of video frames of a live view from the smart box cooler 100, or video frames sent by the smart box cooler 100.

Next, examples of the operation of the network environment 200 are described in further detail. The client application 224 can scan for nearby SmartBox BLE channels broadcasting with characteristics matching “IGLOO BOX” or other pre-defined characteristics. If a SmartBox BLE channel is found, the client application 224 can connect. If a successful Bluetooth connection is established, the client application 224 can query the smart box cooler 100 or the smart box service 203 for an identifier or other data.

The client application 224 can also query the smart box cooler 100 for a list of available WiFi networks discovered by the smart box cooler 100 during a setup process. If the smart box cooler 100 does not connect, the user can be directed to an alternate path. The user can be directed to manually provide WiFi and password info and a Quick Response (QR) code or other type of matrix barcode can be generated using those credentials. Then the client application 224 can display the QR code for scanning by an input device 116 of the smart box cooler 100.

The client application 224 can render a code in the user interface 230 that can be subsequently input to the input device 116 to associate the user of the client device 206 with the particular smart box cooler 100. The client application 224 can generate a user interface 230 containing a Master PIN page that is used to define a keypad entry PIN for the smart box cooler 100 that is stored locally in the smart box cooler 100 for use in the event the user needs to gain access or to open the smart box cooler 100 outside of any other delivery-based PINs that may be created through the client device 206.

The client application 224, a browser, or other application of the client device 206 can be used to place an order with an online retailer for delivery to a home or other location associated with the smart box cooler 100. A delivery user or other user of the smart box cooler 100 can arrive at the location with items for delivery.

An electrically operated actuator 151 of the delivery assembly 112 of the smart box cooler 100 can cause the lock knob 118 from rotating or the lock mechanism 120 from being unlocked. The lock knob 118 can be freed in a number of ways. The smart box cooler application 221 can cause the at least one input device 116 to obtain an initiation action comprising a barcode, PIN, or other authorization data, and free the lock knob 118 to rotate.

In an instance in which the authorization data is determined to be authorized, the at least one computing device of the smart box cooler 100 can initiate access to the at least one cavity of the smart box cooler 100. The authorization data can be determined to be authorized for example by checking the authorization data against a bar code, a PIN, or a voice print stored in the data store 212. The computing device of the delivery assembly 112 can energize the electrically operated actuator 151 to initiate access to one cavity of the smart box cooler 100.

In an example, the smart box cooler application 221 can cause a barcode to be scanned, determine the barcode is authorized, and initiate access to the cavity. In another example, the smart box cooler application 221 can obtain a PIN entered into the keypad 116a, determine the PIN is authorized, and initiate access to the cavity. The smart box cooler application 221 can cause the lock knob 118 to be freed so the lock knob 118 can be rotated. The delivery user or other user of the smart box cooler 100 can manually rotate the lock knob 118 to the unlocked position causing the lock mechanism 120 to be unlocked. The delivery lid 106 can be opened and access to the cavity of the smart box cooler 100 provided.

A thermal storage divider 124 in the cavity of the smart box cooler 100 can define a first cavity 125 that can maintain a food safe temperature for at least five hours. The driver can place groceries in the smart box cooler 100, grouping the frozen & chilled products into the first cavity 125. A second cavity 126 can be defined by the liner 104 and the thermal storage divider 124. Ambient items can be placed in the second cavity 126.

The liner 104 comprises the support element 123 that supports the wire basket 127 configured to suspend at least one thermal storage member 134 in the first cavity 125. The driver can place the at least one thermal storage member 134 in the wire basket 127, which can be located above the frozen/chilled products.

The delivery lid 106 can be closed, and the lock knob 118 rotated to the locked position, causing the lock mechanism 120 to be locked. The smart box cooler 100 can transmit a status to the smart box service 203 or the client device 206 indicating a delivery has been made.

The consumer or other user of the smart box cooler 100 can unlock the lock mechanism 120 to retrieve the items, for example by presenting a PIN, a face, or other information to the input device 116 that the smart box cooler 100 can determine to be authorized.

Shipment delivery date and time, retailer information, PINS, and other information can be populated in the data store 212 in a number of ways. The administration application 215 can include a listener configured to ingest delivery emails from retailers and parcel services such as FedEx, UPS, Walmart, and Kroger. Order and shipment confirmation emails or other messages can be received by the administration application 215. The administration application 215 can process the messages to parse or extract order data and delivery data, which the administration application 215 can then respectively store as the orders 245 and the deliveries 248. In some examples, the administration application 215 can populate the orders 245 or the deliveries 248 by querying the third-party system 208. The administration application 215 can render a user interface 230 or send a notification message that notifies a user of the client device 206 that there are new orders or deliveries.

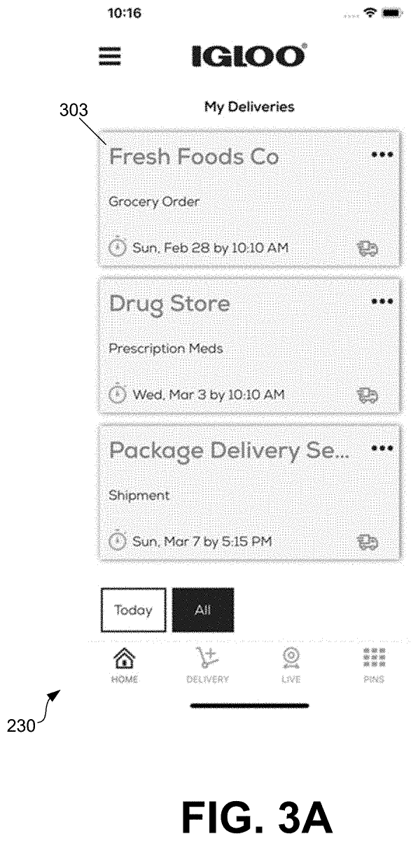

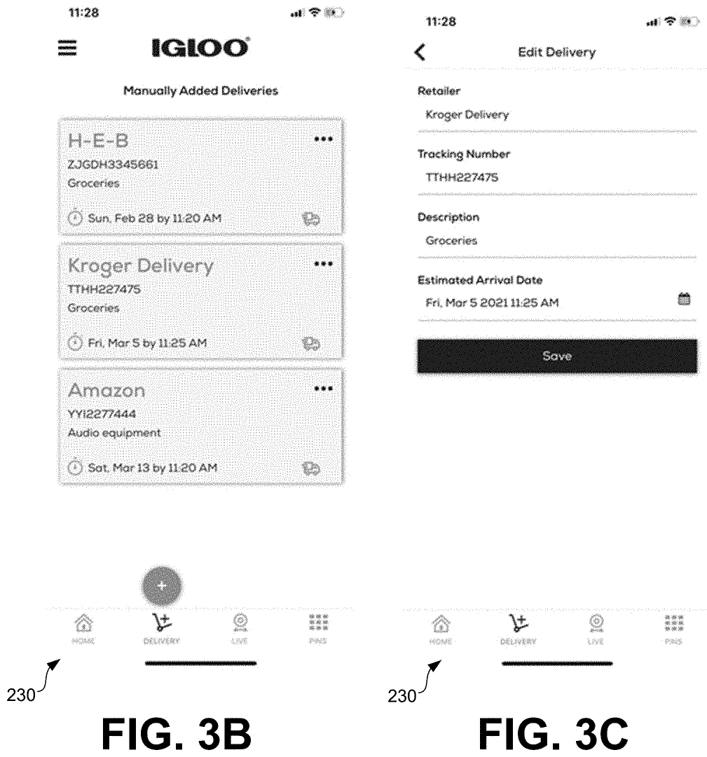

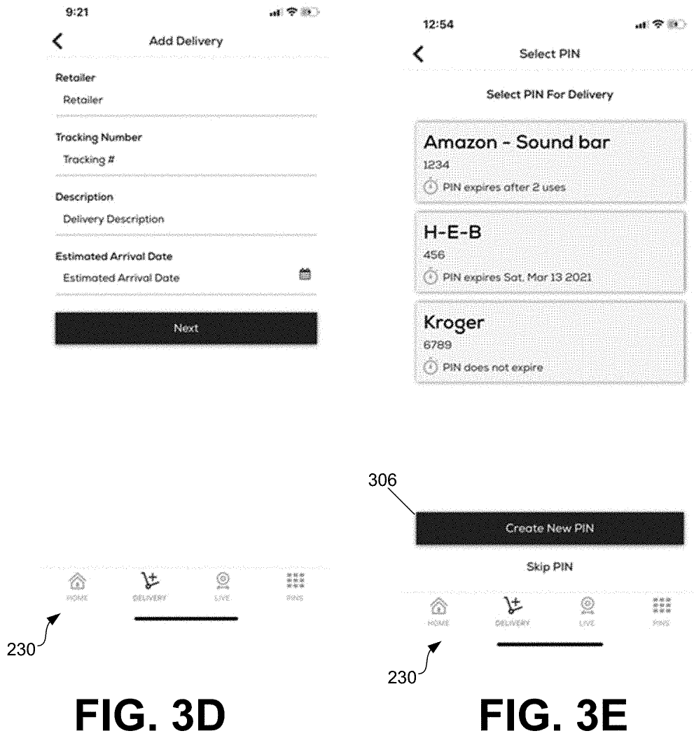

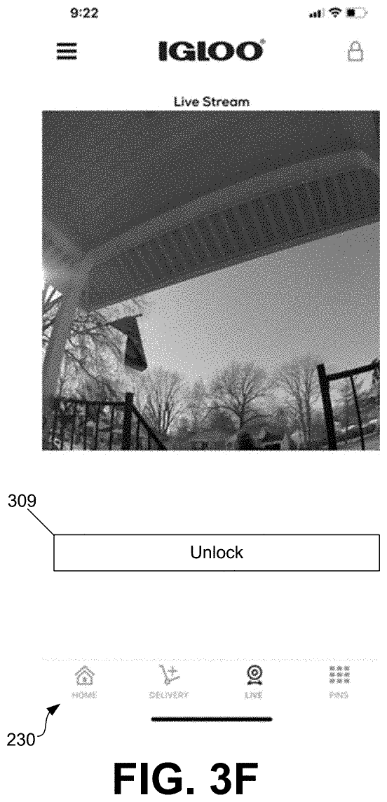

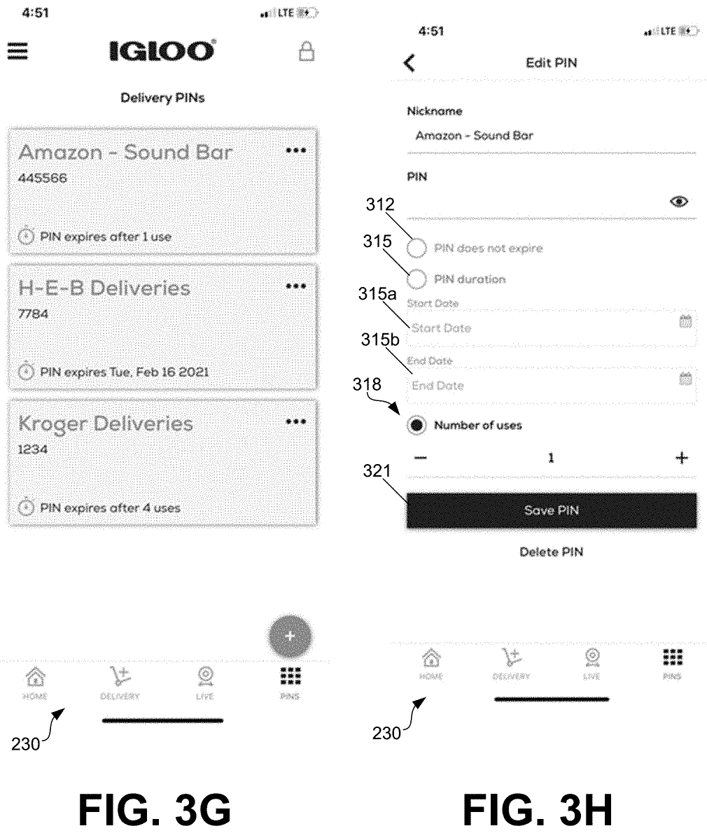

FIGS. 3A-3H are drawings of user interfaces according to various embodiments of the present disclosure. FIG. 3A depicts the user interface 230 can include a Home page or My Deliveries page with information about the orders 245 or the deliveries 248 for a user of a particular smart box cooler 100. The example of FIG. 3A shows there is a grocery order from “Fresh Foods Co” scheduled to arrive at the smart box cooler 100 on Sunday, February 28 by 10:10 am, a prescription medication order from “Drug Store” scheduled to arrive on Wednesday, March 3 by 10:10 am, and a package delivery service shipment scheduled to arrive on Sunday, March 7 by 5:15 pm.

The client application 224 can render the user interface 230 with a visual representation of an aggregation of planned or executed deliveries. The user interface 230 can include, based at least in part on the orders 245 and/or the deliveries 248, the ability to filter by either “All” deliveries or deliveries expected “Today.” A delivery item can display details that include a delivery name, a tracking number, a delivery route and expected arrival date.

The user interface 230 can include a user interface element 303 that, if selected, cause details on events for that particular delivery to be displayed. If the delivery was made details can include delivery arrival date and time, and any recording(s) 251 of the delivery.

The client application 224 can render a user interface 230 that includes PINs that can be used to access the smart box cooler 100. For example, a PIN can be assigned by the user to someone for access to the smart box cooler 100. The PINs that have been created can be displayed in the user interface 230, including details such as Nickname, PIN and Expiration. PINs for example can be set to never expire, have an expiration date, or set to expire after a predefined number of uses. PINs can be also be added, edited, or deleted using the user interface 230.

FIG. 3B shows a Manually Added Deliveries page rendered in the user interface 230 on the display 227 of the client device 206. The Manually Added Deliveries page can include deliveries from the deliveries 248 that have been added by the user. A manually added delivery can show details of the particular delivery such as Delivery Name, Tracking Number, Description and Expected Arrival Date.

FIG. 3C shows the user interface 230 can include an Edit Delivery screen where the fields Retailer, Tracking Number, Description and Estimated Arrival Date are filled with the values from the data store 212 can be edited. FIG. 3D shows the user interface 230 can include an Add Delivery page configured to allow a user to create the deliveries 248 by entering Delivery Name, Tracking Number, Description and Estimated Delivery Date.

FIG. 3E shows the user interface 230 can include features for adding, editing, or deleting PINs. A user can navigate the user interface 230 to select from a previously created PIN or to select a “Create New PIN” button or other user interface element 306 to create a new PIN for the delivery user or a delivery service provider to access the smart box cooler 100.

FIG. 3F shows the user interface 230 can include a page with a live view from the smart box cooler 100, or video frames sent by the smart box cooler 100. The page can be accessed to connect the client application 224 to the smart box cooler 100 and view video from the camera 116b or other input device 116 of the smart box cooler 100.

The client application 224 can render the user interface 230 to allow a user to view video from the camera 116b of the smart box cooler 100. In operation, the client application 224 can cause the smart box cooler 100 to begin streaming video. The client application 224 can connect to a streaming service provided by the video application 218, and render live streaming video on the user interface 230. The live stream can be recorded and stored as the recordings 251 in the data store 212.

FIG. 3F depicts that an unlock user interface element 309 has been rendered in the user interface 230. In an instance in which the unlock user interface element 309 is selected in the user interface 230, the client device 206 can initiate access to at least one cavity of the smart box cooler 100.

In FIG. 3G, the user interface 230 includes a PINs page (or a delivery pin user interface) configured to render delivery PINs. The PINs can be displayed in the “Delivery PINs” list and show details for Nickname, PIN and Expiration.

FIG. 3H shows the user interface 230 can include an Edit Pin page. The user interface 230 is configured to obtain a Nickname, a PIN, and an expiration option. There can be three expiration types to choose from. A “PIN does not expire” option can allows a PIN to be created that may never expire and can be used indefinitely. An “Expiration duration” option can allow a PIN to be created with a start and end date for when it is valid. A “Number of uses” option can allow a PIN to be created that is valid for up to a predefined number of uses.

As depicted in FIG. 3H, the user interface 230 can include at least one of a plurality of selectable user interface elements 312, 315, 315a, 315b, 318, and 321. The selectable user interface element 312 can be configured to receive an indication that the PIN does not expire. The selectable user interface element 315 can be configured to receive a PIN duration. In some examples, the user interface 230 includes the selectable user interface element 315a or the selectable user interface element 315b, which are respectively configured to receive a start date of the PIN and an expiration of the PIN. The selectable user interface element 318 can be configured to receive a predefined number of uses of the PIN. The client device 206 can receive, in the delivery pin user interface, a selection of at least one of the selectable user interface elements 312, 315, 315a, 315b, and 318 associated with a particular PIN.

The selectable user interface element 321, when selected, can cause the client device 206 to transmit, based at least in part on the selection, at least one of: the indication that the PIN does not expire, the expiration date of the PIN, or the predefined number of uses of the PIN. For example, the client device 206 can transmit the indication, the expiration date, or the predefined number of uses to the smart box service 203 or the smart box cooler 100.

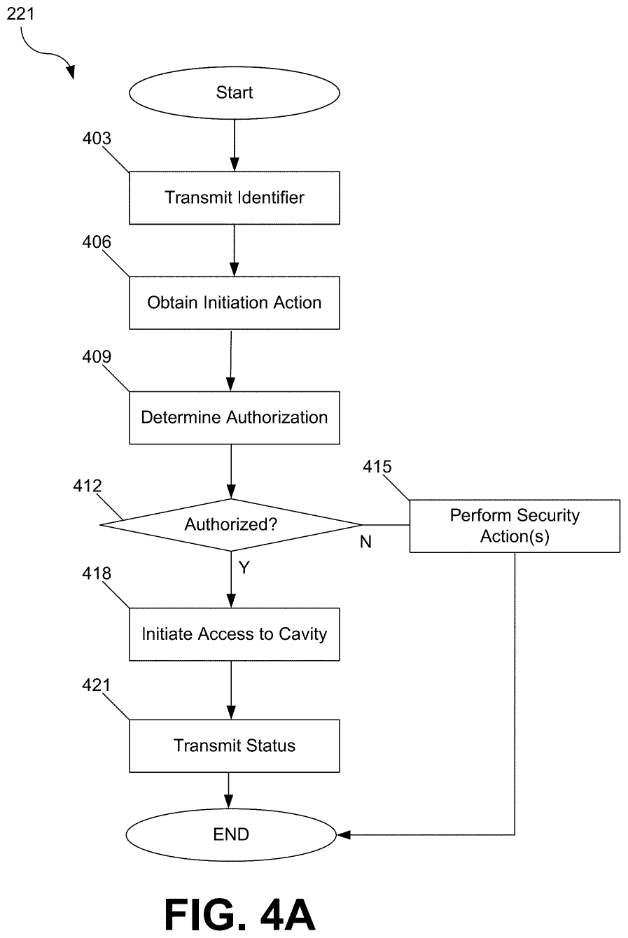

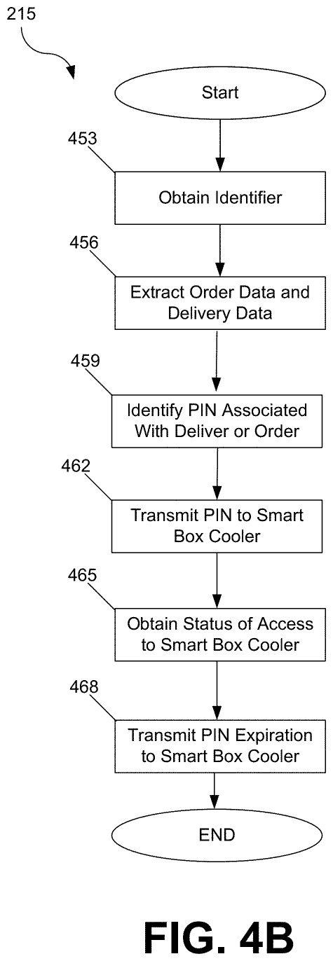

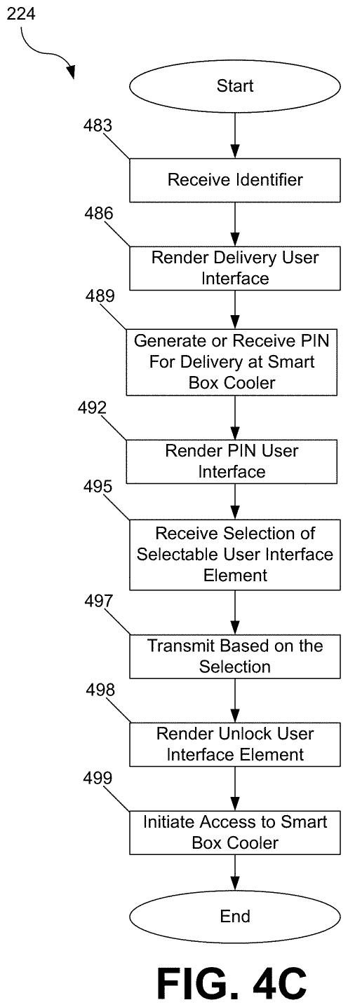

FIG. 4A is an example flowchart illustrating functionalities implemented by a smart box cooler application 221 of the smart box cooler 100 according to various embodiments of the present disclosure. Beginning at box 403, smart box cooler application 221 can transmit an identifier over the network 209. The identifier can uniquely identify the smart box cooler 100 from among other ones of the smart box coolers 100.

At box 406, the smart box cooler application 221 can obtain an initiation action. For example, the initiation action can be obtained by receiving an input to one of the input devices 116. The input device 116 can include the camera 116b, the keypad 116a, a scanner, or a microphone. The initiation action can involve a keypress being received at the keypad 116a, a barcode being presented to the camera 116b, or any suitable action at the smart box cooler 100. In other examples, the initiation action can involve movement of the smart box cooler 100 detected by the sensor module 119.

At box 409, the smart box cooler application 221 can determine authorization data. In some examples, obtaining the initiation action, at box 406, comprises obtaining authorization data received by the at least one input device 116 of the smart box cooler 100. The smart box cooler application 221 can obtain the authorization data received by the keypad 116a, which can be a personal identification number (PIN).

At box 412, the smart box cooler application 221 can determine whether the authorization data determined at box 406 is authorized. For example, the smart box cooler application 221 can check the authorization data against data available to the smart box cooler application 221, such as the user data 236 or the smart box cooler data 239. In some instances, the authorization data can be associated with a delivery user or other user of the smart box cooler 100. The smart box cooler application 221 can check the authorization data against a personal identification number (PIN) sent by the smart box service 203 or a personal identification number (PIN) sent by the client device 206. If the authorization is determined to be authorized, the method can proceed to box 418. Otherwise, the method can proceed to box 415.

At box 415, the smart box cooler application 221 can perform a security action. In an example described above with respect to box 406, the initiation action can involve movement of the smart box cooler 100 detected by the sensor module 119. The smart box cooler 100 can include a display, a siren, a speaker, a status indicator, or other suitable one or more output devices 117. The smart box cooler application 221 can cause the siren or any of the output devices 117 to activate, which can provide a warning associated with the initiation action, a delivery event, or authorization data determined not to be authorized. Thereafter, the process can proceed to completion.

At box 418, the smart box cooler application 221 can initiate access to at least one cavity of the smart box cooler 100 in an instance in which the authorization data is determined to be authorized. In some examples, the smart box cooler application 221 can activate the electrically operated actuator 151 to control access to at least one cavity of the smart box cooler 100. The at least one cavity can include the first cavity 125 (FIG. 1E) or the second cavity 126 (FIG. 1E). Activating the electrically operated actuator 151 can prevent the lock mechanism 120 of the smart box cooler 100 from being unlocked.

In some aspects, activating the electrically operated actuator 151 can include the smart box cooler application 221 causing the electrically operated actuator 151 to be energized. In some other aspects, activating the electrically operated actuator 151 can include the smart box cooler application 221 causing the electrically operated actuator 151 to be deenergized.

The smart box cooler application 221 can initiate access to at least one cavity of the smart box cooler 100 in a number of ways. In one example, the at least one input device 116 comprises the keypad 116a. The smart box cooler application 221 can obtain, by the keypad 116a, a first personal identification number associated with a delivery user. In an instance in which access to the at least one cavity of the smart box cooler 100 is initiated for the delivery user, the smart box cooler application 221 can transmit a notification to the client device 206. The smart box cooler application 221 can obtain, by the keypad 116a, a second personal identification number, and determine that the second personal identification number is associated with a user of the client device 206. In some examples, the smart box cooler application 221 can initiate access to the at least one cavity of the smart box cooler 100 for the user of the client device 206.

At box 421, the smart box cooler application 221 can transmit a status. The smart box cooler 100 including the smart box cooler application 221, the smart box service 203, or the client device 206 can be in communication over the network 209. Accordingly, the status can be transmitted to the smart box service 203 or the client device 206. In some examples, the status can indicate whether access to at least one cavity of the smart box cooler 100 has been provided. Thereafter, the process can proceed to completion.

FIG. 4B is an example flowchart illustrating functionalities implemented by an administration application 215 according to various embodiments of the present disclosure. Beginning at box 453, the administration application 215 can obtain an identifier of the smart box cooler 100. At box 456, the administration application 215 can identify a delivery comprising at least one item of an order. In some examples, the administration application 215 extracts order data associated with the order and delivery data associated with the delivery from an email or other message. In some other examples, the administration application 215 generates a user interface 230 that is configured to receive delivery data associated with the delivery from the client device 206.

At box 459, the administration application 215 can identify a personal identification number (PIN) associated with the delivery (or the deliveries 248) or the order (or the orders 245). The administration application 215 can identify the user data 236 comprising a personal identification number that is associated with the delivery or the order.

At box 462, the administration application 215 can transmit the personal identification number (PIN) to the smart box cooler 100. The administration application 215 can transmit at least one of: an indication that the PIN does not expire, an expiration date of the PIN, or a predefined number of uses of the PIN to the smart box cooler 100. At box 465, the administration application 215 can obtain a status that indicates whether access to at least one cavity of the smart box cooler 100 has been provided.

The administration application 215 can also obtain a plurality of video frames sent by (or taken by) the camera 116b of the smart box cooler 100. In some examples, the administration application 215 can generate a user interface 230 configured to render a video based at least in part on the plurality of video frames.

At box 468, the administration application 215 can transmit a PIN expiration to the smart box cooler 100. In an example, the administration application 215 can determine a number of uses of the PIN. In an instance in which the number of uses of the PIN is equal to a predefined number, the administration application 215 can cause an expiration of the PIN, and transmit an indication of the expiration to the smart box cooler 100. Thereafter, the process can proceed to completion.

FIG. 4C is an example flowchart illustrating functionalities implemented by a client application 224 according to various embodiments of the present disclosure. Beginning at box 483, the client application 224 can receive an identifier of the smart box cooler 100 over the network 209. At box 486, the client application 224 can render a delivery user interface (e.g., the user interface 230 depicted in FIG. 3B) comprising delivery data associated with at least one item of an order placed by a user of the client device 206.

At box 489, the client application 224 can generate or receive a personal identification number (PIN) for a delivery of the at least one item at the smart box cooler 100. At box 492, the client application 224 can render a delivery pin user interface (e.g., the user interface 230 depicted in FIG. 3G or 3H).

The delivery pin user interface can include at least one of a plurality of selectable user interface elements (e.g., selectable user interface elements 312, 315, 315a, 315b, 318, and 321). The selectable user interface element 312 can be configured to receive an indication that the PIN does not expire. The selectable user interface element 315b can be configured to receive an expiration date of the PIN. The selectable user interface element 318 can be configured to receive a predefined number of uses of the PIN. The selectable user interface element 321, when selected, can save the PIN.

At box 495, the client application 224 can receive, in the delivery pin user interface rendered in box 492, a selection of at least one of the selectable user interface elements 312, 315, 315a, 315b, 318, or 321. At box 497, the client application 224 can transmit, based at least in part on the selection received at box 495, at least one of: the indication that the PIN does not expire, the expiration date of the PIN, or the predefined number of uses of the PIN. In some examples, the client application 224 transmits the indication, the expiration date, or the predefined number of uses to the smart box service 203 or the smart box cooler 100.

At box 498, the client application 224 can render a video user interface (e.g., the user interface 230 depicted in FIG. 3F) comprising a video based at least in part on a plurality of video frames sent by the smart box cooler 100. The user interface 230 can include the unlock user interface element 309 (FIG. 3F).

At box 499, the client application 224 can initiate access to at least one cavity of the smart box cooler 100 in an instance in which the unlock user interface element 309 is selected in the user interface 230 rendered by the client device 206. In some aspects of the client application 224, the client device 206 can receive a notification in an instance in which access to at least one cavity of the smart box cooler 100 is initiated.

In still further examples, the client device 206 can receive a request to access at least one cavity of the smart box cooler 100. The client application 224 can render the user interface 230 comprising the unlock user interface element 309. In an instance in which the unlock user interface element is selected, the client application 224 can transmit a response that can initiate access to the at least one cavity of the smart box cooler 100. Thereafter, the process can proceed to completion.

In experimental results, an iterative test process was used to determine how to achieve and maintain food-safe temperatures (FST) inside a smart box cooler 100 with groceries. Tests included: 2 Test environments: outdoor & indoor/lab with outdoor tests (variable ambient temperature) and indoor tests (controlled oven temperature); ice variants: no ice, bagged cubes, hard ice blocks, soft gel packs, dry ice; hard ice block variations: 2 pound, 2.5 pound, and 5 pound; 4 soft gel pack variations: three pound, four pound, six pound, and 6 pound (drain-safe); 2 divider styles: non-insulated plastic cutting board and PU foam insulated thermal storage divider; wire basket that held ice substitutes near top of smart box cooler 100 above cold/frozen food; Groceries: varied from 4 to 24 items, commonly with 24 items with a ratio of 50% ambient, 33% chilled and 17% frozen items.

Learnings and takeaways from these tests included: sorting & grouping cold & frozen foods together and ambient groceries together can improve the cooling capability of ice substitutes; compartmentalizing sorted/grouped groceries using an insulated divider can significantly reduce heat transfer within the smart box cooler 100; elevating ice substitutes above cold & frozen foods can chills the compartment; dry ice is capable of achieving FST, however it can be expensive ($15 each piece) and can pose injury risks; freezing point ice blocks can be an excellent substitute for dry ice, but can be expensive ($25 each) and a minimum of 7.5 pounds or 3 blocks may be needed to maintain FST up to 8 hours; and 12 pounds is a quantity of ice substitutes that can keep groceries at FST for 8 hours.

A number of software components are stored in the memory of a computing device and are executable by a processor. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory including random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory can include both volatile and nonvolatile memory and data storage components. Volatile components are those that do not retain data values upon loss of power. Nonvolatile components are those that retain data upon a loss of power. Thus, the memory can comprise random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM can comprise static random access memory (SRAM), dynamic random access memory (DRAM), or magnetic random access memory (MRAM) and other such devices. The ROM can comprise a programmable read-only memory (PROM), an erasable programmable read-only memory (EPROM), an electrically erasable programmable read-only memory (EEPROM), or other like memory device. Also, the processor can represent multiple processors and/or multiple processor cores and the memory can represent multiple memories that operate in parallel processing circuits, respectively.

The non-transitory computer-readable medium embodying program instructions can represent any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Although the applications or services described herein can be embodied in software or code executed by general purpose hardware that is specially configured or programmed as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components. Such technologies are generally well known by those skilled in the art and, consequently, are not described in detail herein.

Although the flowcharts show a specific order of execution, it is understood that the order of execution can differ from that which is depicted. For example, the order of execution of two or more blocks can be scrambled relative to the order shown. Also, two or more blocks shown in succession in the flowcharts can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

For any figure shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation, and are not meant to limit the embodiments described herein. In the various embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The terms “a,” “an,” and “the” are intended to include plural alternatives, e.g., at least one. The terms “including”, “with”, and “having”, as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Numerical end points of ranges disclosed herein are approximate, unless excluded by proviso.

Values, ranges, or features may be expressed herein as “about”, from “about” one particular value, and/or to “about” another particular value. When such values, or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means±20% of the stated value, ±15% of the stated value, ±10% of the stated value, ±5% of the stated value, ±3% of the stated value, or ±1% of the stated value.

Although embodiments described herein are made with reference to various embodiments, it should be appreciated by those skilled in the art that various modifications are well within the scope of this disclosure. Those skilled in the art will appreciate that the various embodiments described herein are not limited to any specifically discussed application and that the embodiments described herein are illustrative and not restrictive. From the description of the various embodiments, equivalents of the elements shown therein will suggest themselves to those skilled in the art, and ways of constructing other embodiments using the present disclosure will suggest themselves to practitioners of the art. Therefore, the scope of the various embodiments is not limited herein.

1. A method of a smart box cooler comprising a computing device, the method comprising:
transmitting, by the computing device, an identifier over a network;
obtaining, by the computing device, an initiation action comprising authorization data;
determining, by the computing device, whether the authorization data is authorized; and
activating, by the computing device, an electrically operated actuator to control access to at least one cavity of the smart box cooler, wherein activating the electrically operated actuator prevents a lock mechanism of the smart box cooler from being unlocked based at least in part by preventing a lock knob from fully turning to an unlocked position.

2. The method of claim 1, wherein activating the electrically operated actuator comprises the computing device causing the electrically operated actuator to be energized.

3. The method of claim 1, wherein activating the electrically operated actuator comprises the computing device causing the electrically operated actuator to be deenergized.

4. The method of claim 1, further comprising:
in an instance in which the authorization data is determined to be authorized, initiating, by the computing device, access to the at least one cavity of the smart box cooler.

5. (canceled)

6. The method of claim 1, wherein obtaining the initiation action comprising obtaining the authorization data received by at least one input device of the smart box cooler.

7. The method of claim 6, wherein the at least one input device comprises a camera, a keypad, a scanner, or a microphone.

8. The method of claim 7, wherein:
the at least one input device comprises the keypad; and
obtaining the authorization data comprises obtaining a first personal identification number associated with a delivery user, the method further comprising:
in an instance in which access to the at least one cavity of the smart box cooler is initiated for the delivery user, transmitting, by the computing device, a notification to a client device;
obtaining, by the keypad, a second personal identification number;
determining, by the computing device, that the second personal identification number is associated with a user of the client device; and
initiating, by the computing device, access to the at least one cavity of the smart box cooler for the user.

9. A system, comprising:
a smart box cooler comprising a computing device; and
program instructions executable in the computing device that, when executed by the computing device, cause the computing device to:
transmit an identifier over a network;
obtain an initiation action comprising authorization data;
determine whether the authorization data is authorized; and
activate an electrically operated actuator to control access to at least one cavity of the smart box cooler, wherein activating the electrically operated actuator prevents a lock mechanism of the smart box cooler from being unlocked based at least in part by preventing a lock knob from fully turning to an unlocked position.

10. The system of claim 9, wherein the program instructions cause the computing device to cause the electrically operated actuator to be energized to activate the electrically operated actuator.

11. The system of claim 9, wherein the program instructions cause the computing device to cause the electrically operated actuator to be deenergized to activate the electrically operated actuator.

12. The system of claim 9, wherein the program instructions cause the computing device to:
in an instance in which the authorization data is determined to be authorized, initiate access to the at least one cavity of the smart box cooler.

13. (canceled)

14. The system of claim 9, wherein the computing device obtains the initiation action comprising authorization data received by at least one input device of the smart box cooler.

15. A non-transitory computer-readable medium storing a plurality of instructions executable by a computing device of a smart box cooler, the plurality of instructions being configured to cause the computing device to at least:
transmit an identifier over a network;
obtain an initiation action comprising authorization data;
determine whether the authorization data is authorized; and
activate an electrically operated actuator to control access to at least one cavity of the smart box cooler, wherein activating the electrically operated actuator prevents a lock mechanism of the smart box cooler from being unlocked based at least in part by preventing a lock knob from fully turning to an unlocked position.

16. The non-transitory computer-readable medium of claim 15, wherein the instructions cause the computing device to cause the electrically operated actuator to be energized to activate the electrically operated actuator.

17. The non-transitory computer-readable medium of claim 15, wherein the instructions cause the computing device to cause the electrically operated actuator to be deenergized to activate the electrically operated actuator.

18. The non-transitory computer-readable medium of claim 15, wherein the instructions are further configured to cause the computing device to at least:
in an instance in which the authorization data is determined to be authorized, initiate access to the at least one cavity of the smart box cooler.

19. (canceled)

20. The non-transitory computer-readable medium of claim 15, wherein the computing device obtains the initiation action comprising authorization data received by at least one input device of the smart box cooler.
